(19) United States
(12) Patent Application Publication
(10) Pub. No.: US 2006/0068851 A1
(43) Pub. Date: Mar. 30, 2006

(54) Accessory device for mobile communication device

(76) Inventor: William C. Ashman JR., Durham, NC (US)

Correspondence Address: COATS & BENNETT/SONY ERICSSON, 1400 CRESCENT GREEN, SUITE 300, CARY, NC, 27511, US

(21) Appl. No.: 10/952,199

(22) Filed: Sep. 28, 2004

(51) Int. Cl. H04B 1/38

(52) U.S. Cl. 455/566

(57) ABSTRACT

An accessory device for a mobile communication device comprises a stylus containing a short-range wireless interface for communicating with the mobile communication device. The stylus can be used conventionally to input data and commands into the mobile communication device via a touch screen. Additionally, the stylus may include an input device to generate an input signal for transmission to said mobile communication device and/or an output device to produce an output responsive to an output signal received from said mobile communication device.

### BACKGROUND OF THE INVENTION

The present invention relates generally to mobile communication devices and more particularly to an accessory device for mobile communication devices.

Some wireless communications devices not only provide the ability to communicate wirelessly via a communications network, but also provide the functionality usually found in Personal Digital Assistants (PDAs) and computers. Address books, browsers, games, and calendaring applications, for example, are often times incorporated with the wireless communications device. Typically, these devices come equipped with a pen-type accessory called a “stylus” that facilitates the accurate selection of items, entering of data, and managing of information on a touchscreen display. The stylus is usually stored in a slot or cavity on the wireless communications device, and removed when the user wishes to interact with the device.

In some cases, after using the stylus, users may forget to replace the stylus in the wireless communications device. Alternatively, the user may prefer to keep the stylus on their person while the relatively bulkier wireless communications device remains nearby, such as on a desktop for example. To use the wireless communications device under these circumstances, such as to place or receive a call, the user must first locate and activate the desired functionality directly on the wireless communications device. Therefore, it would be useful to be able to activate the functionality on the wireless communications device remotely when the stylus and the device are separated.

### SUMMARY OF THE INVENTION

The present invention comprises a mobile communication device and pen-type accessory device. Both the mobile communication device and accessory device include a short-range transceiver for communicating with one another. The accessory device may, for example, comprise a stylus that is used to input data via a touchscreen on the mobile communication device. The stylus may contain an input device to generate an input signal for transmission to the mobile communication device and/or an output device to produce an output responsive to an output signal received from the mobile communication device.

In one embodiment of the invention, the input device comprises a microphone, and the output device comprises a speaker. This embodiment may function similar to a cordless headset. The microphone generates an audio signal for transmission to the mobile communication device via the short-range transceiver. The accessory device may also receive audio signals from the mobile communication device via the short-range transceiver that are applied to the speaker to generate audible sounds.

The accessory device may include manual controls to control operation of the accessory device and/or mobile communication device. For example, the accessory device may include a push button control that is pressed to either answer an incoming call or to initiate an outgoing call.

### BRIEF DESCRIPTION OF THE DRAWINGS

FIG. 1 is a block diagram of an exemplary mobile communication device and accessory device according to the present invention.

FIG. 2 is perspective view of an exemplary mobile communication device and accessory device according to the present invention.

FIGS. 3 and 4 are perspective views illustrating portions of exemplary accessory devices.

FIG. 5 is a flow diagram illustrating the operation of the accessory device in an exemplary embodiment.

FIG. 6 is a flow diagram illustrating the operation of the mobile communication device in an exemplary embodiment.

### DETAILED DESCRIPTION OF THE INVENTION

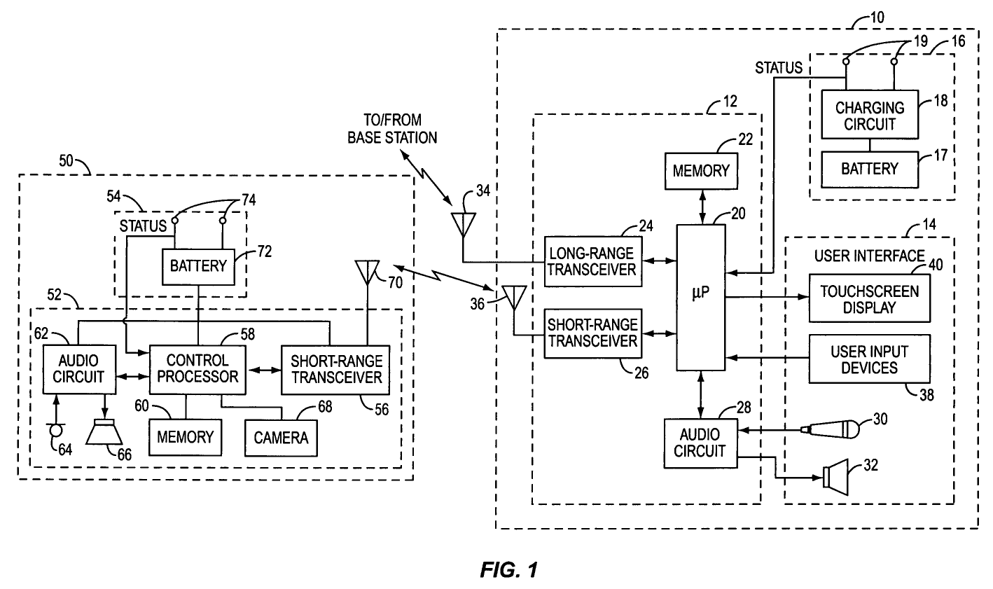

FIG. 1 is a block diagram of an exemplary mobile communication device 10 and associated accessory device 50. The exemplary mobile communication device 10 is a multi-function device that combines a personal digital assistant (PDA) and wireless transceiver. The exemplary embodiment is for illustrative purposes only and is not intended to limit the scope of the invention. Other embodiments will be readily apparent to those skilled in the art.

The mobile communication device 10 comprises a communications circuit 12, a user interface 14, and power circuit 16. The communications circuit 12 enables communications with remote devices via short range and long range wireless interfaces. User interface 14 enables a user to interact with and to control the operation of the mobile communication device 10. Power circuit 16 provides power to the communications circuit 12 and user interface 14.

The communications circuit 12 includes one or more system processors 20, memory 22, long-range transceiver 24, short-range transceiver 26, audio circuit 28, a microphone 30 and speaker 32. System processor 20 performs various processing tasks including control of the overall operation of the mobile communication device 10 according to programs stored in memory 22. The system processor 20 may comprise a single microprocessor or multiple microprocessors, and may be implemented in hardware, firmware, software, or a combination thereof. The microprocessors may be general purpose microprocessors, digital signal processors, or other special purpose processors. The functions performed by the system processor 20 include audio processing, baseband processing, and overall control of the operation of the mobile communication device 10. Memory 22 may include both random access memory (RAM) and read-only memory (ROM). Computer program instructions and data required for operation are stored in non-volatile memory, such as EPROM, EEPROM, and/or flash memory, which may be implemented as discrete devices, stacked devices, or integrated with system processor 20. Audio circuit 28 interfaces with the system processor 20. Audio circuit 28 provides basic analog output signals to speaker 32 and receives analog audio inputs from microphone 30. Microphone 30 converts the user's speech into electrical audio signals, and speaker 32 converts audio signals into audible sounds that can be heard by the user.

Long-range transceiver 24 is coupled to antenna 34 for transmitting signals to and receiving signals from one or more base stations in a wireless communication network. Long-range transceiver 24 is a fully functional cellular radio transceiver, and operates according to any known standard, including Global System for Mobile Communications (GSM), TIA/EIA-136, cdmaOne, cdma2000, UMTS, and Wideband CDMA.

Short-range transceiver 26 is coupled to antenna 36 for communicating with nearby devices, such as a desktop computer or other mobile communication device 10. In one embodiment, short-range transceiver 26 is a BLUETOOTH transceiver or RF transceiver operating according to the IEEE 802.11(b) or 802.11(g) standards. As is well known in the art, BLUETOOTH is a universal radio interface that permits the creation of ad hoc networks, and is particularly well-suited for communications over short distances. For further details regarding BLUETOOTH technology, the interested reader may refer to “Bluetooth—The Universal Radio Interface for ad hoc, wireless connectivity,” presented by Jaap Haartsen in Ericsson Review No. 3, 1998, which is herein incorporated by reference. It should be understood, however, that short-range transceiver 26 may utilize any technology known in the art operable to transmit and receive signals over short distances, for example, infra-red, and hardwired cables.

The user interface 14 includes one or more user input devices 38 and a display 40. The user input devices may include a keypad, touchpad, joystick control, dials, control buttons, voice recognition system, other input devices, or a combination thereof. Display 40 allows the operator to view information such as menus and menu items, dialed digits, images, call status information, and output from user applications. In a preferred embodiment of the invention, the display 40 comprises a touchscreen that also functions as a user input device.

Power circuit 16 supplies power to the mobile communication device 10. Power circuit 16 includes a rechargeable battery 17 and a charging circuit 18 having a pair of charging contacts 19. The charging contacts 19 are used to output a charging current to the accessory device 50 for recharging a battery or other power supply device in the accessory device 50.

The accessory device 50 is a pen-type accessory, such as a stylus that may be used to input data via touch screen display 40. The accessory device 50 contains a communications circuit 52 and a power circuit 54. The communications circuit 52 includes a short-range transceiver 56 for communicating with the mobile communication device 10, a control processor 58, memory 60, audio circuit 62, microphone 64, speaker 66, and camera assembly 68. Short-range transceiver 56 may comprise a BLUETOOTH transceiver or RF transceiver operating according to the IEEE 802.11(b) or 802.11(g) standards. Short-range transceiver 56 couples to antenna 70 and should be compatible with the short-range transceiver 26 in the mobile communication device 10 to enable communications with the mobile communication device 10. Control processor 58 controls operation of the accessory device 50 according to instructions stored in memory 60. Control processor 58 may comprise a single microprocessor or multiple microprocessors, and may be implemented in hardware, firmware, software, or a combination thereof. Memory 60 may include both random access memory (RAM) and read-only memory (ROM). Computer program instructions and data required for operation are stored in non-volatile memory, such as EPROM, EEPROM, and/or flash memory, which may be implemented as discrete devices, stacked devices, or integrated with control processor 58.

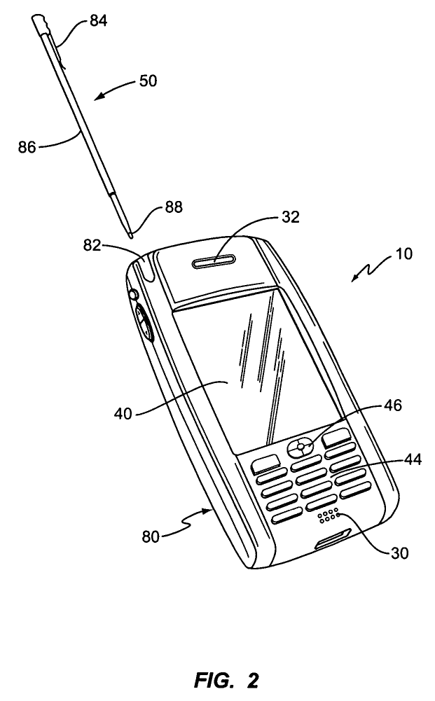

Audio circuit 62 interfaces with the control processor 58. Audio circuit 62 provides basic analog output signals to speaker 66 and receives analog audio inputs from microphone 64. Microphone 64 converts the user's speech into electrical audio signals, and speaker 66 converts audio signals into audible sounds that can be heard by the user. Power circuit 54 provides operating power for the accessory device 50. Power circuit 54 comprises a power source, such as battery 72, electrically coupled to a pair of charging contacts 74. Preferably, the mobile communication device 10 includes a holder 82 (shown in FIG. 2) for the accessory device 50. When the accessory device 50 is inserted into the holder, the charging contacts 74 connect with corresponding charging contacts 19 on the mobile communication device 10 to recharge the battery 72.

Camera 68 may be any camera assembly known in the art, and may include such elements as a lens assembly (not shown), an image sensor (not shown), and an image processor (not shown). Camera 68 captures images that can be digitized and stored in memory 22, 60, digitally altered by control processor 58 and/or processor 20, output to display 40, or transmitted over a wireless network via long-range transceiver 24. As will be described below, short-range transceiver 56 may transmit the captured images to the short-range transceiver 26 in device 10 responsive to some activation of a manual control on accessory device 50, for example.

FIG. 2 illustrates the physical appearance of an exemplary mobile communication device 10 according to the present invention. The mobile communication device 10 includes a housing 80 containing the elements shown in FIG. 1. A keypad 44, joystick control 46, touchscreen display 40, microphone 30, and speaker 32 are disposed on the front of housing 80. The keypad 44 and joystick control 46 serve as user input devices 38. The pen-type accessory device 50 includes an elongate body 86 with a pointed end 88. The housing 80 of the mobile communication device 10 includes a holder 82 to receive the pen-type accessory device 50. The holder 82 in the illustrated embodiment comprises a slot, cavity or opening into which the pen-type accessory device 50 is inserted. The body 86 of the pen-type accessory device 50 includes a groove that engages with a corresponding ridge (not shown) in the slot, cavity or opening to retain the pen-type accessory 50 in the slot, opening or cavity. The pen-type accessory device 50 may further include a clip 84 to engage, for example, a persons clothing.

The pen-type accessory device 50 may be used as a stylus to input data into the mobile communication device 10 by tapping or writing on the touchscreen display 40. The pen-type accessory device 50 also functions as a speaker/microphone accessory in a manner similar to a cordless headset. When the pen-type accessory device 50 is enabled, audible signals are converted by the microphone 64 into audio signals and transmitted to the mobile communication device 10 via the short-range transceiver 56. The mobile communication device 10 may in turn process and transmit the audio signals via long-range transceiver 24. The mobile communication device 10 may also transmit audio signals received by the long-range transceiver 24 to the pen-type accessory device 50 for output by speaker 66. If the mobile communication device 10 is capable of playing back stored sounds or music, the mobile communication device 10 may transmit the prerecorded sounds stored in memory 22 to the accessory device 50 for output by speaker 66. Conversely, sounds detected by the microphone 64 on the accessory device 50 may be transmitted to the mobile communication device 10 for recording and storing in the memory 22 of the mobile communication device 10.

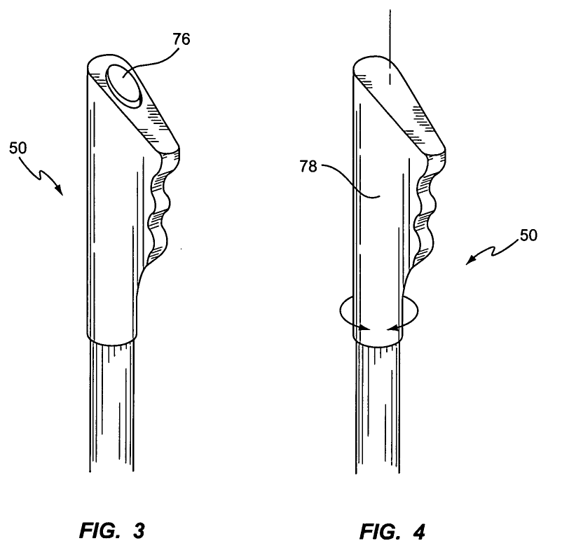

In one embodiment of the invention, the short-range transceiver 56 in the accessory device 50 is automatically enabled when the accessory device 50 is removed from the holder 82. Control processor 58 may, for example, detect a change in current or voltage that occurs when the electrical connection with the mobile communication device 10 is broken. Alternatively, the accessory device 50 may include a mechanical switch, optical detector, proximity detector or other sensor that generates a signal when the accessory device 50 is removed from the holder 82. In other embodiments, the accessory device 50 may include a manual control that can be manually actuated by the user to activate the accessory device 50. The manual control may, for example, comprise a push button as shown in FIG. 3. As another example, the accessory device 50 may have a rotatable element that rotates between two or more positions. The rotatable element may, for example, comprise a rotatable end cap as seen in FIG. 4 that rotates between on and off positions. When activated, the accessory device 50 may send a control signal to the mobile communication device 10 via short-range transceiver 56 to initiate communication with the mobile communication device 10 and to establish a communication channel. The mobile communication device 10 may, when the accessory device 50 is enabled, disable its internal microphone 30 and speaker 32.

Preferably, the accessory device 50 normally operates in a low power mode when it is enabled to conserve battery power, and switches to a high power mode when it is necessary to transmit and/or receive signals to or from the mobile communication device 10. In low power mode, the short-range transceiver 56 may be placed in a sleep mode and periodically awakened to monitor the communication channel between the accessory device 50 and the mobile communication device 10. The mobile communication device 10 may send a control signal to the accessory device 50 responsive to predetermined conditions that causes the accessory device 50 to switch to a high power mode. For example, the mobile communication device 10 may send a control signal to the accessory device 50 responsive to receipt of an incoming call or to initiation of a call by the user. The control processor 58 in the accessory device 50 may also command the short-range transceiver 56 to switch to a high power mode responsive to predetermined conditions. For example, the control processor 58 may monitor the audio signal from the microphone 64 and command the short-range transceiver 56 to switch to high power mode responsive to voice commands. Alternatively, the control processor 58 may process the signal received by the short-range transceiver 56 when it is temporarily awakened and switch the short-range transceiver 56 from low-power mode to high-power mode if a data signal, such as an audio signal, is detected. Similarly, the control processor 58 can switch the short-range transceiver 56 back to low power mode when it no longer detects a data signal from the mobile communication device 10.

In other embodiments, the control processor 58 may be programmed to switch the accessory device 50 between low power and high power modes responsive to user actuation of a manual control, such as a push button 76 or rotary control 78 as seen in FIGS. 3 and 4. For example, the user may press the push button 76 on the accessory device 50 to initiate a call. Responsive to actuation of the push button, the control processor 58 may switch the accessory device 50 to high power and send a control signal to the mobile communication device 10 to initiate a call. Once a call is established, the mobile communication device 10 sends received audio signals to the accessory device 50 for output by speaker 66, and receives audio signals from the microphone 64 on the accessory device 50.

Alternatively, actuation of the manual control 76 or 78 might activate the camera 68 to capture an image. In this embodiment, the control processor 58 would send the captured image to the short-range transceiver 26 of device 10 for storage in memory 22 or display on display 40. As previously stated, a user would then be able to transmit the captured image throughout the network via the long-range transceiver 24.

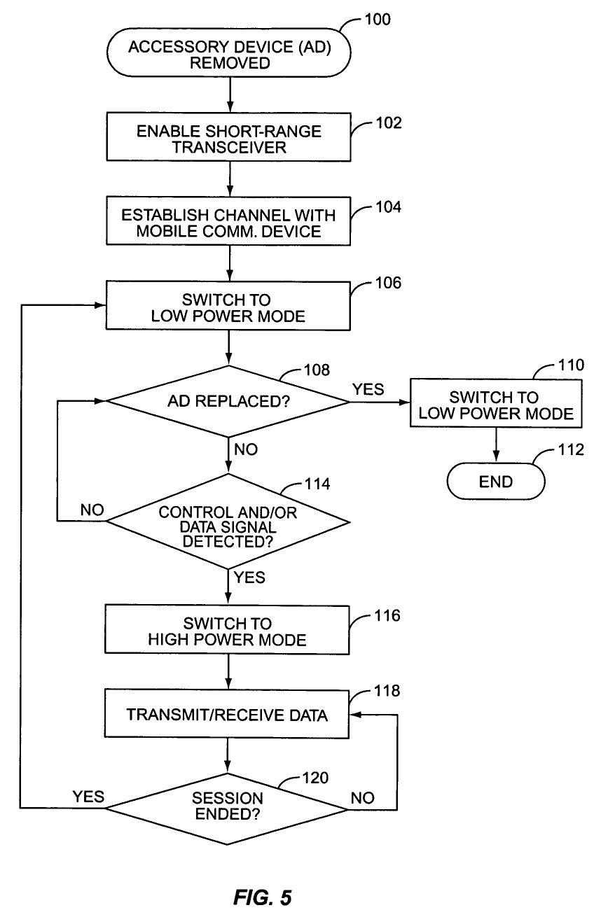

FIG. 5 is a flow diagram illustrating the operation of the accessory device 50 in one exemplary embodiment of the invention. When the control processor 58 senses the removal of the accessory device 50 from the holder 82 (block 100), the control processor 58 enables the short-range transceiver (block 102), establishes a communication channel with the mobile communication device 10 via the short-range transceiver 56 (block 104), and switches the short-range transceiver 56 to a low power mode (block 106).

While the accessory device 50 is in low power mode, the control processor 58 periodically checks whether the accessory device 50 has been replaced into the holder 82 on the mobile communication device 10 (block 108). When the control processor 58 detects the replacement of the accessory device 50 into the holder 82 of the mobile communication device 10, the control processor 58 disables the short-range transceiver 56 (block 110) and the procedure ends (block 112). If the accessory device 50 has not been replaced into the holder 82 of the mobile communication device 10, the control processor 58 next determines whether a control and/or data signal has been received (block 114) that indicates a need to switch to high power mode (block 116). If the accessory device 50 has a manual control, the mobile communication device 10 may monitor a control signal produced by the manual control (e.g., push button 76 or rotary switch 78) and switch to high power mode responsive to the control signal. The control processor 58 may also receive a control signal from the mobile communication device 10 via the short-range transceiver 56. As noted above, the mobile communication device 10 may send a control signal to the accessory device 50 responsive to receipt of an incoming call, initiation of a call by the user, or some other action by the user. In some embodiments of the invention, the control processor 58 may be programmed to recognize the presence of data signals in either the input signal from the microphone 64 or the received signal from the mobile communication device 10. For example, the control processor 58 may recognize speech or other audio signals in the input signal from the microphone 64 or the received signal from the mobile communication device 10. When the control processor 58 detects speech in the input signal or the received signal, the control processor 58 can switch the short-range transceiver 56 to high power mode. There may be circumstances when the user does not want his speech or voice transmitted, such as when the user is engaged in a conversation. To prevent undesired transmission of speech or voice, the control processor 58 can be programmed to switch to high power mode and transmit the input signal from the microphone 64 only in response to recognized voice commands.

When the mobile communication device 10 switches to high power mode (block 116), it begins transmitting data to, and receiving data from, the mobile communication device 10 (block 118). While in the high power mode, the control processor 58 periodically determines whether the transmission or reception of data is complete (block 120). For example, if the user is engaged in a voice call, the control processor 58 may detect when the voice call has ended. Detecting the end of a communication transaction can be accomplished in many ways. The control processor 58 may receive an explicit control signal indicating when the communication transaction is complete. The control signal may be generated responsive to user actuation of the manual control 76, 78 on the accessory device 50, or may be received via the short-range transceiver 56 from the mobile communication device 10. In the latter case, the user may actuate a manual control on the mobile communication device 10 to end the communication session. Responsive to user actuation of the manual control, the mobile communication device 10 may send a control signal to the accessory device 50 via the short-range transceiver 26. The control processor 58 may also determine when a communication session has ended based on the presence or absence of a data signal in either the input signal from the microphone 64 or the receive signal from the mobile communication device 10. When the accessory device 50 determines that the communication session has ended, it switches back to low power mode (block 106).

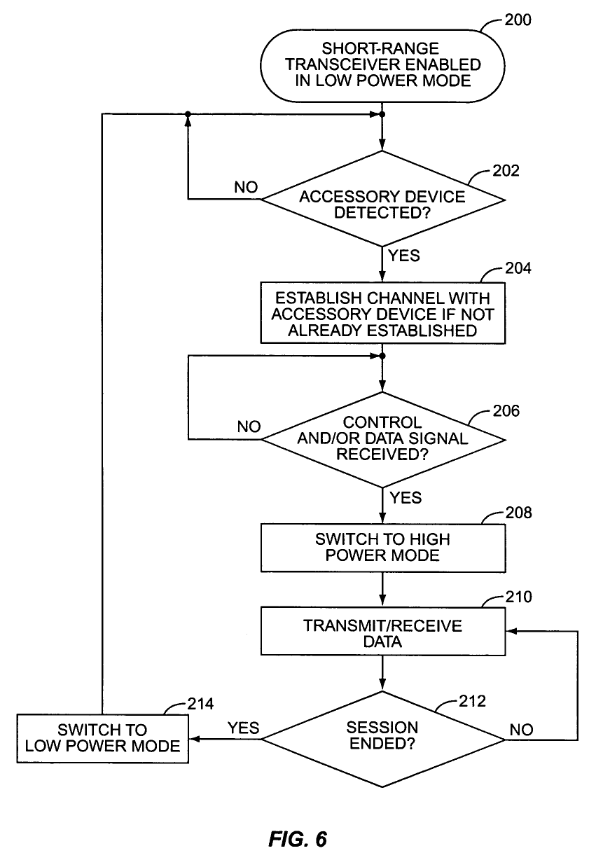

FIG. 6 is a flow diagram illustrating the operation of an exemplary mobile communication device 10. When the short-range transceiver 26 is enabled (block 200), the short-range transceiver continually searches for a signal from the accessory device 50 (block 202). The short-range transceiver 26 may be always enabled, or may be enabled responsive to removal of the accessory device 50. Preferably, the short-range transceiver 26 operates in a low power mode. When in low power mode, the short-range transceiver 26 enters a sleep mode and periodically awakens to search for the signal from the accessory device 50. If the accessory device 50 is detected, the mobile communication device 10 establishes a communication channel with the accessory device 50 if one has not already been established (block 204).

Once the mobile communication device 10 establishes a communication channel, the system processor 20 waits for control and/or data signals indicating a need to transmit data to, or receive data from, the accessory device 50 (block 206) and then switches to a high power mode (block 208). For example, if the user initiates a call, the system processor 20 may switch the short-range transceiver 26 to high power mode and send a control signal to the accessory device 50 to notify the accessory device 50. Similarly, the system processor 20 may switch to high power mode responsive to receipt of an incoming call. The mobile communication device 10 may also receive a control signal from the accessory device 50 initiating a call. In some embodiments, the accessory device 50 may simply begin transmitting the data signal to the mobile communication device 10. The system processor 20 may switch the short-range transceiver 26 to high power mode responsive to detection of the data signal from the accessory device 50.

When the short-range transceiver is in high power mode, the mobile communication device transmits data to and/or receives data from the accessory device 50 (block 210). The system processor 20 detects when the communication session has ended (block 212) and switches back to low power mode (block 214). The accessory device 50 may send an explicit signal terminating the session to the mobile communication device 10 to end the communication session. Similarly, the user may end the communication session by pressing a key on the keypad 44. In some embodiments, the system processor 20 may monitor the signal received from the accessory device 50 and automatically switch to low power mode when the accessory device 50 stops transmitting data.

The present invention may, of course, be carried out in other specific ways than those herein set forth without departing from the scope and essential characteristics of the invention. For example, the accessory device 50 may have only an input device without an output device, or may have an output device without an input device. Similarly, the accessory device 50 may have a transmitter without a receiver, or a receiver without a transmitter. In the described embodiments, the input device comprises a microphone 64 and the output device comprises a speaker 66. Other input and output devices could be contained on the stylus. For example, the input device may comprise a control to control the operation of the mobile communication 10 device and the input signal may be a control signal generated responsive to actuation of the control. As another example, the output device may comprise a light or tactile generator. For example, the stylus may include a vibrator that vibrates responsive to a control signal from the mobile communication device to announce an incoming call. Those skilled in the art will no doubt think of many other input and output signals. The present embodiments are, therefore, to be considered in all respects as illustrative and not restrictive, and all changes coming within the meaning and equivalency range of the appended claims are intended to be embraced therein.

What is claimed is:

1. An accessory for a mobile communication device comprising:
a stylus for inputting data to said mobile communication device via a touchscreen display on said mobile communication device;
an input device on said stylus to generate an input signal; and
a transmitter on said stylus operatively coupled to the input device to transmit said input signal to said mobile communication device.

2. The accessory of claim 1 wherein said input device comprises a microphone.

3. The accessory device of claim 1 wherein said input device comprises a camera.

4. The accessory device of claim 1 further comprising a battery in said stylus providing power to said input device and transmitter.

5. The accessory device of claim 1 further comprising a control processor to selectively enable and disable said transmitter.

6. The accessory device of claim 5 wherein said control processor is operative to enable and disable said transmitter responsive to the state of a status signal indicating whether the accessory device is stored.

7. The accessory device of claim 5 wherein said transmitter is operable in a low power mode and a high power mode.

8. The accessory device of claim 7 wherein said transmitter switches between low power mode and high power modes responsive to a control signal.

9. The accessory device of claim 8 further comprising a manual control to generate a control signal, and wherein said control processor is operative to detect said control signal and selectively switch said transmitter between said low power and high power modes.

10. The accessory device of claim 8 wherein said transmitter switches between low power and high power modes responsive to an input signal from said input device.

11. The accessory device of claim 10 wherein said transmitter switches between low power and high power modes based on the presence or absence of said input signal.

12. The accessory device of claim 10 wherein said input device is a microphone and wherein said transmitter switches between low power and high power modes responsive to detection of voice commands from a user.

13. The accessory device of claim 1 further comprising a receiver to receive an output signal from said mobile communication device and an output device to generate an output responsive to said output signal received from said mobile communication device.

14. The accessory device of claim 13 wherein said input device comprises a microphone and wherein said output device comprises a speaker.

15. An accessory for a mobile communication device comprising:
a stylus for inputting data to said mobile communication device via a touchscreen display on said mobile communication device;
a receiver on said stylus operative to receive an output signal from said mobile communication device; and
an output device on said stylus coupled to said receiver to produce an output responsive to the output signal.

16. The accessory device of claim 15 wherein said output device comprises a speaker.

17. The accessory device of claim 15 further comprising a battery in said stylus providing power to said output device and said receiver.

18. The accessory device of claim 15 further comprising a control processor to selectively enable and disable said receiver.

19. The accessory device of claim 18 wherein said control processor is operative to selectively enable and disable said receiver responsive to the state of a status signal indicating whether the accessory device is stored.

20. The accessory device of claim 15 wherein said receiver is operable in a low power mode and a high power mode.

21. The accessory device of claim 20 wherein said receiver switches between low power mode and high power modes responsive to a control signal.

22. The accessory device of claim 21 further comprising a manual control to generate a control signal, and wherein said control processor is operative to detect said control signal and selectively switch said receiver between said low power and high power modes.

23. The accessory device of claim 21 wherein said control signal is received by said receiver from said mobile communication device.

24. The accessory device of claim 20 wherein said receiver switches between low power and high power modes based on the presence or absence of a data signal from said mobile communication device.

25. The accessory device of claim 1 further comprising an input device to generate an input signal, and a transmitter to transmit said input signal to said mobile communication device

26. The accessory device of claim 25 wherein said input device comprises a microphone and wherein said output device comprises a speaker.

27. A communication device comprising:
a mobile communication device including:
a long-range transceiver for communicating with a base station in a mobile communication network;
a short-range transceiver for communicating with nearby devices; and
a touchscreen display;
an accessory device including:
a stylus for inputting data to said mobile communication device via said touchscreen display;
an input device on said stylus to produce an input signal;
an output device on said stylus to generate and output responsive to an output signal; and
a short-range transceiver on said stylus to transmit said input signal to said mobile communication device and to receive said output signal from said mobile communication device.

28. The communication device of claim 27 wherein said input device comprises a microphone and wherein said output device comprises a speaker.

29. The communication device of claim 27 wherein said input device comprises a camera.

30. The communication device of claim 27 further comprising a battery to power said accessory device.

31. The communication device of claim 27 further comprising a control processor in said accessory device to selectively enable and disable said short-range transceiver in said accessory device.

32. The communication device of claim 31 wherein said control processor is operative to enable and disable said short-range transceiver responsive to the state of a status signal indicating whether the accessory device is in use.

33. The communication device of claim 31 wherein said short-range transceiver is operable in a low power mode and a high power mode.

34. The communication device of claim 33 wherein said short-range transceiver switches between low power mode and high power modes responsive to a control signal.

35. The communication device of claim 34 further comprising a manual control to generate a control signal, and wherein said control processor is operative to detect said control signal and selectively switch said short-range transceiver between said low power and high power modes.

36. The communication device of claim 33 wherein said short-range transceiver switches between low power and high power modes responsive to an input signal from said input device.

37. The communication device of claim 36 wherein said short-range transceiver switches between low power and high power modes based on the presence or absence of said input signal from said input device.

38. The communication device of claim 37 wherein said input device is a microphone and wherein said transmitter switches between low power and high power modes responsive to detection of voice commands from a user.

39. A method of communicating between a wireless communications device and an accessory of the wireless communications device, the method comprising:
establishing a communications channel between a first short-range transceiver in a wireless communications device and a second short-range transceiver in a stylus;
detecting a signal indicative of information to be communicated over the established communications channel; and
communicating the information over the established communications channel responsive to the detected signal.

40. The method of claim 39 further comprising placing the first short-range transceiver in a low power mode once the communications channel is established.

41. The method of claim 40 further comprising placing the first short-range transceiver in a high power mode responsive to the detection of the signal.

42. The method of claim 41 further comprising placing the first short-range transceiver back into the low power mode once the communications have ended.

43. The method of claim 39 further comprising placing the second short-range transceiver in a low power mode once the communications channel is established.

44. The method of claim 43 further comprising placing the second short-range transceiver in a high power mode responsive to the detection of the signal.

45. The method of claim 44 further comprising placing the second short-range transceiver back into the low power mode once the communications have ended.

46. The method of claim 39 wherein the signal is generated by the wireless communications device and detected by the stylus.

47. The method of claim 46 wherein the signal is generated by the wireless communications device responsive to the receipt of an incoming call from a wireless communications network.

48. The method of claim 39 wherein the signal is generated by the stylus and detected by the wireless communications device.

49. The method of claim 48 wherein the signal is generated by the stylus responsive to the detection of the user's voice at a microphone on the stylus.

50. The method of claim 48 wherein the signal is generated by the stylus responsive to the manipulation of an actuator disposed on the stylus.

51. The method of claim 39 further comprising detecting when the stylus is not mated with the wireless communications device.

52. The method of claim 51 wherein establishing a communications channel between the first and second short-range transceivers is done responsive to detecting when the stylus is not mated with the wireless communications device.

53. The method of claim 51 further comprising detecting when the stylus is mated with the wireless communications device.

54. The method of claim 53 further comprising placing at least one of the first and second short-range transceivers in a low power mode responsive to detecting that the stylus is mated with the wireless communications device.

55. The method of claim 53 further comprising disabling at least one of the first and second short-range transceivers responsive to detecting that the stylus is mated with the wireless communications device.

56. The method of claim 39 further comprising recharging a power source in the stylus when the stylus is mated with the wireless communications device.

57. The method of claim 39 further comprising enabling one of an input device and an output device on the stylus responsive to detecting the signal.

58. The method of claim 39 wherein communicating the information over the established communications channel comprises generating an output signal at the stylus responsive to an output signal generated by the wireless communications device.

59. The method of claim 39 wherein communicating the information over the established communications channel comprises generating an output signal at the wireless communications device responsive to an output signal generated by the stylus.
